(19) United States
(12) Patent Application Publication
(10) Pub. No.: US 2025/0271641 A1
(43) Pub. Date: Aug. 28, 2025

(54) CAMERA OPTICAL LENS

(71) Applicant: AAC OPTICS (CHANGZHOU) CO., LTD., Changzhou City (CN)

(72) Inventors: Tao Zhang, Changzhou (CN); Shunda Zhou, Changzhou (CN)

(21) Appl. No.: 18/731,405

(22) Filed: Jun. 3, 2024

(30) Foreign Application Priority Data
Feb. 28, 2024 (CN) 202410219462.6

(51) Int. Cl. G02B 13/00; G02B 9/60

(52) U.S. Cl. CPC G02B 13/0045; G02B 9/60; G02B 13/0055

(57) ABSTRACT

The present disclosure relates to the field of optical lenses, and more specifically to a camera optical lens. The camera optical lens includes five lenses, which include, from an object side to an image side in sequence: a first lens having a positive refractive power, a second lens having a positive refractive power, a third lens having a negative refractive power, a fourth lens having a positive refractive power, and a fifth lens having a negative refractive power. The camera optical lens satisfies following relationships: 3.00≤f2/f≤12.00; 1.10≤(R9+R10)/(R9−R10)≤1.90; 1.00≤d1/d2≤4.00; and 2.00≤R6/R5≤15.00. The camera optical lens according to the present disclosure can meet the design requirement of large aperture, wide-angle and ultra-thinness.

### CROSS REFERENCE TO RELATED APPLICATIONS

The present application claims the benefit of priority under the Paris Convention to Chinese Patent Application No. 202410219462.6, entitled “CAMERA OPTICAL LENS,” filed on Feb. 28, 2024, which is incorporated herein by reference in its entirety.

### TECHNICAL FIELD

The present disclosure relates to optical lens, in particular to a camera optical lens suitable for handheld devices, such as smart phones and digital cameras, and imaging devices, such as monitors and PC.

### BACKGROUND

With the emergence of smart phones in recent years, the demand for miniature camera lens is increasing day by day. Due to the reduction in pixel size of photosensitive devices, coupled with the current development trend of electronic products being that their functions should be better and their shape should be thin and small, miniature camera lens with good imaging quality therefor has become a mainstream in the market. In order to obtain better imaging quality, the lens adopts a multiple-piece lens structure. And, with the development of technology and the increase of the diverse demands of users, and under this circumstances that the pixel area of photosensitive devices is shrinking steadily and the requirement of the system for the imaging quality is improving constantly, the five-piece lens structure gradually appear in lens design. There is an urgent need for wide-angle camera lenses which have good optical characteristics, small volume, and the chromatic aberration of which is fully corrected.

### SUMMARY

In view of the above, the present disclosure is intended to provide a camera optical lens, which has good optical characteristics and satisfies the design requirements of large aperture, ultra-thinness, and wide angle.

In order to achieve the above objective, a solution of the present disclosure provides a camera optical lens. The camera optical lens includes five lenses. The five lenses include, from an object side to an image side in sequence: a first lens having a positive refractive power, a second lens having a positive refractive power, a third lens having a negative refractive power, a fourth lens having a positive refractive power, and a fifth lens having a negative refractive power. The camera optical lens satisfies following relationships: 3.00≤f2/f≤12.00; 1.10≤(R9+R10)/(R9−R10)≤1.90; 1.00≤d1/d2≤4.00; and 2.00≤R6/R5 ≤15.00. Where, f represents a focal length of the camera optical lens, f2 represents a focal length of the second lens, R9 represents a central curvature radius of an object-side surface of the fifth lens, R10 represents a central curvature radius of an image-side surface of the fifth lens, d1 represents an on-axis thickness of the first lens, d2 represents an on-axis distance from an image-side surface of the first lens to an object-side surface of the second lens, R5 represents a central curvature radius of an object-side surface of the third lens, and R6 represents a central curvature radius of an image-side surface of the third lens.

As an improvement, the camera optical lens further satisfies a following relationship: 1.00≤d6/d8≤3.00. Where, d6 represents an on-axis distance from the image-side surface of the third lens to an object-side surface of the fourth lens, and d8 represents an on-axis distance from an image-side surface of the fourth lens to the object-side surface of the fifth lens.

As an improvement, the camera optical lens further satisfies a following relationship: −4.00≤f3/f≤−1.20; where, f3 represents a focal length of the third lens.

As an improvement, an object-side surface of the first lens is convex in a paraxial region and an image-side surface of the first lens is concave in the paraxial region. The camera optical lens further satisfies a following relationship: 0.68≤f1/f≤2.31; −3.87≤(R1+R2)/(R1−R2)≤−1.13; and 0.04≤d1/TTL≤0.25; where f1 represents a focal length of the first lens, R1 represents a central curvature radius of the object-side surface of the first lens, R2 represents a central curvature radius of the image-side surface of the first lens, and TTL represents a total track length of the camera optical lens.

As an improvement, the object-side surface of the second lens is convex in a paraxial region. The camera optical lens further satisfies a following relationship: −2.65≤(R3+R4)/(R3−R4)≤−0.38; and 0.04≤d3/TTL≤0.15; where R3 represents a central curvature radius of the object-side surface of the second lens, R4 represents a central curvature radius of an image-side surface of the second lens, d3 represents an on-axis thickness of the second lens, and TTL represents a total track length of the camera optical lens.

As an improvement, the object-side surface of the third lens is concave in a paraxial region and the image-side surface of the third lens is convex in the paraxial region. The camera optical lens further satisfies a following relationship: −5.98≤(R5+R6)/(R5−R6)≤−0.76; and 0.03≤d5/TTL≤0.12; where d5 represents an on-axis thickness of the third lens and TTL represents a total track length of the camera optical lens.

As an improvement, an image-side surface of the fourth lens is convex in a paraxial region. The camera optical lens further satisfies a following relationship: 0.28≤f4/f≤1.32; 0.43≤(R7+R8)/(R7−R8)≤2.45; and 0.05≤d7/TTL≤0.24; where f4 represents a focal length of the fourth lens, R7 represents a central curvature radius of an object-side surface of the fourth lens, R8 represents a central curvature radius of the image-side surface of the fourth lens, d7 represents an on-axis thickness of the fourth lens, and TTL represents a total track length of the camera optical lens.

As an improvement, the object-side surface of the fifth lens is convex in a paraxial region and the image-side surface of the fifth lens is concave in the paraxial region. The camera optical lens further satisfies a following relationship: −2.42≤f5/f≤−0.39; and 0.07≤d9/TTL≤0.29; where f5 represents a focal length of the fifth lens, d9 represents an on-axis thickness of the fifth lens and TTL represents a total track length of the camera optical lens.

As an improvement, the camera optical lens further satisfies a following relationship: TTL/IH≤1.40; where TTL represents a total track length of the camera optical lens and IH represents a maximum image height of the camera optical lens.

As an improvement, the camera optical lens further satisfies a following relationship: 0.50≤f12/f≤1.94; where f12 represents a combined focal length of the first lens and the second lens.

The present disclosure has the beneficial effects in that: the camera optical lens according to the present disclosure has good optical performance, has the characteristics of large aperture, wide-angle and ultra-thinness and is particularly suitable for mobile phone camera lens assemblies and WEB camera lenses composed of camera elements such as charge coupled device (CCD) or complementary metal-oxide semiconductor sensor (CMOS sensor) for high pixels.

### BRIEF DESCRIPTION OF THE DRAWINGS

In order to more clearly illustrate the technical solutions in the embodiments of the present disclosure, the accompanying drawings to be used in the description of the embodiments will be briefly described below, and it is obvious that the accompanying drawings in the following description are only some of the embodiments of the present disclosure, and that, for a person of ordinary skill in the art, it is possible to obtain other drawings based on these drawings without any creative effort.

FIG. 1 is a schematic diagram of a camera optical lens in accordance with a first embodiment of the present disclosure.

FIG. 2 shows the longitudinal aberration of the camera optical lens shown in FIG. 1.

FIG. 3 shows the lateral color of the camera optical lens shown in FIG. 1.

FIG. 4 presents a schematic diagram of the field curvature and distortion of the camera optical lens shown in FIG. 1.

FIG. 5 is a schematic diagram of a camera optical lens in accordance with a second embodiment of the present disclosure.

FIG. 6 shows the longitudinal aberration of the camera optical lens shown in FIG. 5.

FIG. 7 shows the lateral color of the camera optical lens shown in FIG. 5.

FIG. 8 presents a schematic diagram of the field curvature and distortion of the camera optical lens shown in FIG. 5.

FIG. 9 is a schematic diagram of a camera optical lens in accordance with a third embodiment of the present disclosure.

FIG. 10 shows the longitudinal aberration of the camera optical lens shown in FIG. 9.

FIG. 11 shows the lateral color of the camera optical lens shown in FIG. 9.

FIG. 12 presents a schematic diagram of the field curvature and distortion of the camera optical lens shown in FIG. 9.

FIG. 13 is a schematic diagram of a camera optical lens in accordance with a fourth embodiment of the present disclosure.

FIG. 14 shows the longitudinal aberration of the camera optical lens shown in FIG. 13.

FIG. 15 shows the lateral color of the camera optical lens shown in FIG. 13.

FIG. 16 presents a schematic diagram of the field curvature and distortion of the camera optical lens shown in FIG. 13.

FIG. 17 is a schematic diagram of a camera optical lens in accordance with a comparative example.

FIG. 18 shows the longitudinal aberration of the camera optical lens shown in FIG. 17.

FIG. 19 shows the lateral color of the camera optical lens shown in FIG. 17.

FIG. 20 presents a schematic diagram of the field curvature and distortion of the camera optical lens shown in FIG. 17.

### DETAILED DESCRIPTION OF THE EMBODIMENTS

In order to make the objectives, technical solutions and advantages of the present disclosure clearer, various embodiments of the present disclosure will be described in detail below in connection with the accompanying drawings. However, a person of ordinary skill in the art should understand that in the various embodiments of the present disclosure, a number of technical details have been proposed in order to enable the reader to better understand the present disclosure. However, even without these technical details and various variations and modifications based on the following embodiments, the technical solutions claimed to be protected by the present disclosure can be realized.

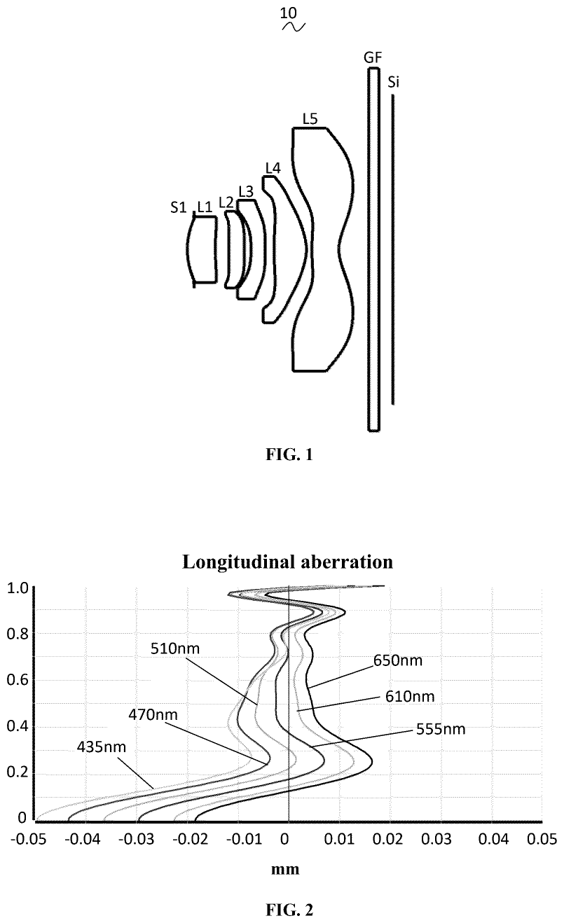

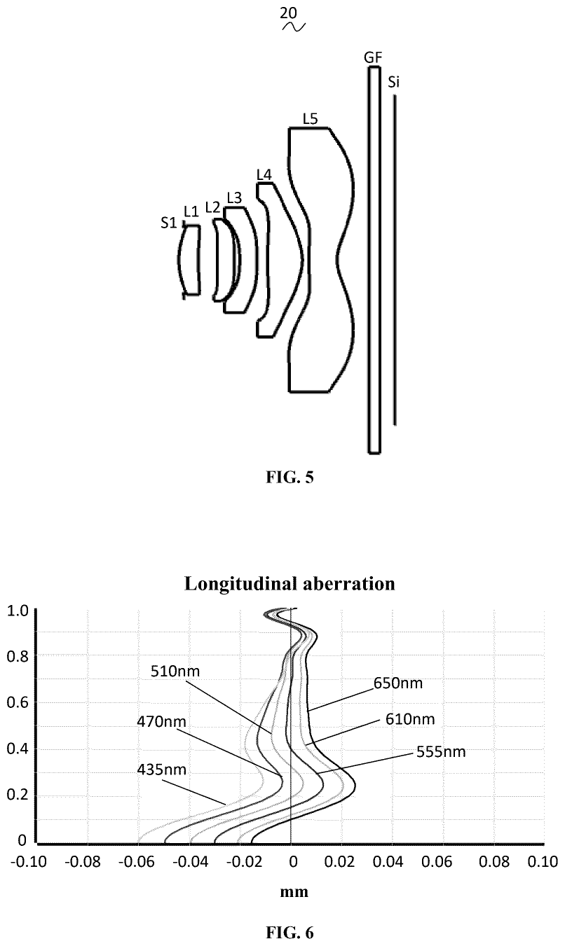

As referring to the figures, the present disclosure provides a camera optical lens 10, 20, 30 and 40. FIG. 1, FIG. 5, FIG. 9 and FIG. 13 show the camera optical lens 10, 20, 30 and 40 of the present disclosure, respectively. The camera optical lens 10, 20, 30 and 40 include 5 lenses, respectively. Specifically, from the object side to the image side, the camera optical lens includes in sequence: an aperture S1, a first lens L1, a second lens L2, a third lens L3, a fourth lens L4, and a fifth lens L5. Optical element like optical filter GF can be arranged between the fifth lens L5 and the image surface Si.

The first lens L1 is made of plastic material, the second lens L2 is made of plastic material, the third lens L3 is made of plastic material, the fourth lens L4 is made of plastic material, and the fifth lens L5 is made of plastic material. Each lens may also be made of other materials.

Here, the focal length of the whole camera optical lens is defined as f, the focal length of the second lens L2 is defined as f2. The camera optical lens further satisfies the following relationship formula: 3.00≤f2/f≤12.00, by which, a ratio of the focal length of the second lens L2 and the focal length f of the whole camera optical lens is specified, and within the range of the relationship formula, the camera optical lens is made to have better imaging quality and lower sensitivity by a reasonable distribution of the optical focal length of the camera optical lens.

The curvature radius of the object-side surface of the fifth lens L5 is defined as R9, the curvature radius of the image-side surface of the fifth lens L5 is defined as R10. The following relationship formula should be satisfied: 1.10≤(R9+R10)/(R9−R10)≤1.90, by which, the shape of the fifth lens L5 is fixed, and it is conducive to correcting the astigmatism and distortion of the camera optical lens, to enable the distortion to satisfy |Distortion|≤2.7%, such that the generation of dark corners can be reduced.

The on-axis thickness of the first lens L1 is defined as d1, and the on-axis distance from the image-side surface of the first lens L1 to the object-side surface of the second lens L2 is defined as d2. The following relationship formula should be satisfied: 1.00≤d1/d2≤4.00, by which, a ratio of the on-axis thickness d1 of the first lens L1 and the on-axis distance d2 from the image-side surface of the first lens L1 to the object-side surface of the second lens L2 is specified. Within the range of the relationship formula, it is conducive to reducing the total optical length of the whole camera optical lens.

The curvature radius of the object-side surface of the third lens L3 is defined as R5, the curvature radius of the image-side surface of the third lens L3 is defined as R6. The following relationship formula should be satisfied: 2.00≤R6/R5≤15.00, which is beneficial for the shaping of the third lens L3. Within the range of the relationship formula, a degree of deflection of light passing through the lens can be alleviated, and aberrations can be effectively corrected, thus enabling the chromatic aberration to satisfy |LC|≤5.0 μm.

When the above relationship formulas are satisfied, each of the camera optical lenses 10, 20, 30, and 40 has good optical performance and can meet the design requirement of large aperture, wide-angle and ultra-thinness. According to the characteristics of the camera optical lenses 10, 20, 30 and 40, the camera optical lenses 10, 20, 30, 40, and 50 are particularly suitable for mobile phone camera lens assemblies and WEB camera lenses composed of camera elements such as charge coupled device (CCD) or complementary metal-oxide semiconductor sensor (CMOS sensor) for high pixels.

Based on the above relationship formulas and the functions that can be realized, the characteristics of each lens of the lenses are further refined as follows.

The on-axis distance from the image-side surface of the third lens L3 to the object-side surface of the fourth lens L4 is defined as d6, and the on-axis distance from the image-side surface of the fourth lens L4 to the object-side surface of the fifth lens L5 is defined as d8. The following relationship formula should be satisfied: 1.00≤d6/d8≤3.00, by which, a ratio of the air spacing between the third lens L3 and the fourth lens L4 and the air spacing between the fourth lens L4 and the fifth lens L5 is specified. Within the range of the relationship formula, it is conducive to reducing the total optical length of the whole camera optical lens.

The focal length of the third lens L3 is defined as f3, satisfying the following relationship formula: −4.00≤f3/f≤−1.20, by which, a ratio of the focal length of the third lens L3 and the focal length f of the whole camera optical lens is specified, and within the range of the relationship formula, the camera optical lens is made to have better imaging quality and lower sensitivity by reasonably distributing the optical focal length of the camera optical lens.

An object-side surface of the first lens L1 is convex in a paraxial region and the image-side surface of the first lens L1 is concave in the paraxial region, and the first lens L1 has a positive refractive power. The object-side surface and image-side surface of the first lens L1 may also be provided in other concave and convex distributions.

The focal length of the first lens L1 is defined as f1, satisfying the following relationship formula: 0.68≤f1/f≤2.31, by which, a ratio of the focal length of the first lens L1 and the focal length f of the whole camera optical lens is specified. Within the specified range, the first lens L1 has an appropriate positive refractive power, which is conducive to reducing systematic aberration, and at the same time is conducive to the development of the lens to ultra-thin and wide-angle.

The curvature radius of the object-side surface of the first lens L1 is defined as R1, the curvature radius of the image-side surface of the first lens L1 is defined as R2. The following relationship formula should be satisfied: −3.87≤(R1+R2)/(R1−R2)≤−1.13. By reasonably controlling the shape of the first lens L1, the first lens L1 can effectively correct the system spherical aberration. Preferably, the relationship formula −2.42≤(R1+R2)/(R1−R2)≤−1.41 shall be satisfied.

The on-axis thickness of the first lens L1 is defined as d1, and the total track length of the camera optical lens is defined as TTL. The following relationship formula: 0.04≤d1/TTL≤0.25 should be satisfied. Within the range of the relationship formula, it is beneficial for realization of the ultra-thin lens. Preferably, the relationship formula 0.07≤d1/TTL≤0.20 shall be satisfied.

The object-side surface of the second lens L2 is convex in a paraxial region and an image-side surface of the second lens L2 is concave or convex in the paraxial region, and the second lens L2 has a positive refractive power. The object-side surface of the second lens L2 may also be provided in other concave and convex distributions.

The curvature radius of the object-side surface of the second lens L2 is defined as R3, the curvature radius of the image-side surface of the second lens L2 is defined as R4. The following relationship formula should be satisfied: −2.65≤(R3+R4)/(R3−R4)≤−0.38, which specifies the shape of the second lens L2. Within the range of the relationship formula, it is beneficial to correct the problem of on-axis color aberration with the development of lenses to ultra-thin and wide-angle. Preferably, the relationship formula −1.65≤(R3+R4)/(R3−R4)≤−0.47 shall be satisfied.

The on-axis thickness of the second lens L2 is defined as d3. The following relationship formula: 0.04≤d3/TTL≤0.15 should be satisfied. Within the range of the relationship formula, it is beneficial for realization of the ultra-thin lens. Preferably, the relationship formula 0.06≤d3/TTL≤0.12 shall be satisfied.

The object-side surface of the third lens L3 is concave in a paraxial region and the image-side surface of the third lens L3 is convex in the paraxial region, and the third lens L3 has a negative refractive power. The object and image-side surfaces of the third lens L3 may also be provided in other concave and convex distributions.

The camera optical lens may further satisfy the following relationship formula: −5.98≤(R5+R6)/(R5−R6)≤−0.76, by which, the shape of the third lens L3 is specified, and it is beneficial for the shaping of the third lens L3. Within the range of the relationship formula, a degree of deflection of light passing through the lens can be alleviated, and aberrations can be effectively corrected. Preferably, the relationship formula of −3.74≤(R5+R6)/(R5−R6)≤−0.95 shall be satisfied.

The on-axis thickness of the third lens L3 is defined as d5. The following relationship formula: 0.03≤d5/TTL≤0.12 should be satisfied. Within the range of the relationship formula, it is beneficial for realization of the ultra-thin lens. Preferably, the relationship formula 0.05≤d5/TTL≤0.10 shall be satisfied.

The object-side surface of the fourth lens L4 is concave or convex in a paraxial region and the image-side surface of the fourth lens L4 is convex in the paraxial region, and the fourth lens L4 has a positive refractive power. The image-side surface of the fourth lens L4 may also be provided in other concave and convex distributions.

The focal length of the fourth lens L4 is f4. The following relationship formula should be satisfied: 0.28≤f4/f≤1.32. The system is made to have better imaging quality and lower sensitivity by reasonably distributing the optical focal length of the camera optical lens. Preferably, the relationship formula 0.44≤f4/f≤1.06 shall be satisfied.

The curvature radius of the object-side surface of the fourth lens L4 is defined as R7, the curvature radius of the image-side surface of the fourth lens L4 is defined as R8. The following relationship formula should be satisfied: 0.43≤(R7+R8)/(R7−R8)≤2.45, by which, the shape of the fourth lens L4 is specified. Within the range of the relationship formula, it is conducive to correcting a problem of an off-axis aberration with the development into the direction of ultra-thin and wide-angle lenses. Preferably, the following relationship formula shall be satisfied, 0.68≤(R7+R8)/(R7−R8)≤1.96.

The on-axis thickness of the fourth lens L4 is defined as d7. The following relationship formula: 0.05≤d7/TTL≤0.24 should be satisfied. With the range of the relationship formula, it is beneficial for realization of the ultra-thin lens. Preferably, the relationship formula 0.09≤d7/TTL≤0.19 shall be satisfied.

The object-side surface of the fifth lens L5 is convex in a paraxial region and the image-side surface of the fifth lens L5 is concave in the paraxial region, and the fifth lens L5 has a negative refractive power. The object-side surface and image-side surface of the fifth lens L5 may also be provided in other concave and convex distributions.

The focal length of the fifth lens L5 is f5. The following relationship formula should be satisfied: −2.42≤f5/f≤−0.39, which can effectively smooth the light angles of the camera optical lens and reduce the tolerance sensitivity. Preferably, the relationship formula −1.51≤f5/f≤−0.49 should be satisfied.

The on-axis thickness of the fifth lens L5 is defined as d9. The following relationship formula: 0.07≤d9/TTL≤0.29 should be satisfied. Within the range of the relationship formula, it is beneficial for realization of the ultra-thin lens. Preferably, the relationship formula 0.10≤d9/TTL≤0.23 shall be satisfied.

The maximum image height of the camera optical lens is defined as IH, which satisfies the following relationship formula: TTL/IH≤1.40.

The combined focal length of the first lens L1 and the second lens L2 is defined as f12, which satisfies the following relationship formula: 0.50≤f12/f≤1.94. Within the range of the relationship formula, it is beneficial for avoiding the aberration and distortion of the camera optical lens, suppressing the rear focal length, and maintaining the miniaturization of image lens system groups. Preferably, the relationship formula 0.80≤f12/f≤1.56 should be satisfied.

The field of view (FOV) of the camera optical lens is greater than or equal to 90.00°, thereby realizing wide-angle.

The aperture value (focal number, FNO) of the camera optical lens is less than or equal to 2.11, thereby realizing a large aperture, such that the camera optical lens has good imaging performance.

The camera optical lens of the present disclosure will be explained with specific embodiments illustrated below. The symbols described in each embodiment are shown below. The unit of the focal length, the on-axis distance, the central curvature radius, the on-axis thickness, inflexion point positions, and arrest point positions is mm.

TTL: total track length (the on-axis distance from the object-side surface of the first lens L1 to the image surface Si), and unit of the TTL being in mm.

Aperture value (focal number, FNO): a ratio of the effective focal length of the camera optical lens to the diameter of the pupil.

The technical proposal of the present disclosure will be described in detail in four embodiments, and a comparative example will be provided as a reference for illustration. The technical effect of the present disclosure could not be achieved when value of the parameters exceeds beyond the range of the above-mentioned conditional formula.

### First Embodiment

Table 1 and table 2 show design data of the camera optical lens 10 according to the first embodiment of the present disclosure.

TABLE 1

| | R | d | | nd | | vd | |
|---|---|---|---|---|---|---|---|
| S1 | ∞ | d0 = | −0.147 | | | | |
| R1 | 1.677 | d1 = | 0.586 | nd1 | 1.5444 | v1 | 55.82 |
| R2 | 5.467 | d2 = | 0.283 | | | | |
| R3 | 13.018 | d3 = | 0.325 | nd2 | 1.5444 | v2 | 55.82 |
| R4 | −51.907 | d4 = | 0.139 | | | | |
| R5 | −3.661 | d5 = | 0.295 | nd3 | 1.6700 | v3 | 19.39 |
| R6 | −18.147 | d6 = | 0.192 | | | | |
| R7 | −44.437 | d7 = | 0.672 | nd4 | 1.5444 | v4 | 55.82 |
| R8 | −0.953 | d8 = | 0.115 | | | | |
| R9 | 7.875 | d9 = | 0.562 | nd5 | 1.5444 | v5 | 55.82 |
| R10 | 0.866 | d10 = | 0.629 | | | | |
| R11 | ∞ | d11 = | 0.210 | ndg | 1.5168 | vg | 64.17 |
| R12 | ∞ | d12 = | 0.293 | | | | |

The meaning of the various symbols is as follows.
S1: aperture;
R: the curvature radius at the center of the optical surface;
R1: the central curvature radius of the object-side surface of the first lens L1;
R2: the central curvature radius of the image-side surface of the first lens L1;
R3: the central curvature radius of the object-side surface of the second lens L2;
R4: the central curvature radius of the image-side surface of the second lens L2;
R5: the central curvature radius of the object-side surface of the third lens L3;
R6: the central curvature radius of the image-side surface of the third lens L3;
R7: the central curvature radius of the object-side surface of the fourth lens L4;
R8: the central curvature radius of the image-side surface of the fourth lens L4;
R9: the central curvature radius of the object-side surface of the fifth lens L5;
R10: the central curvature radius of the image-side surface of the fifth lens L5;
R11: the central curvature radius of the object-side surface of the optical filter GF;
R12: the central curvature radius of the image-side surface of the optical filter GF;
d: the on-axis thickness of the lens and the on-axis distance between the lenses;
d0: the on-axis distance from the aperture S1 to the object-side surface of the first lens L1;
d1: the on-axis thickness of the first lens L1;
d2: the on-axis distance from the image-side surface of the first lens L1 to the object-side surface of the second lens L2;
d3: the on-axis thickness of the second lens L2;
d4: the on-axis distance from the image-side surface of the second lens L2 to the object-side surface of the third lens L3;
d5: the on-axis thickness of the third lens L3;
d6: the on-axis distance from the image-side surface of the third lens L3 to the object-side surface of the fourth lens L4;
d7: the on-axis thickness of the fourth lens L4;
d8: the on-axis distance from the image-side surface of the fourth lens L4 to the object-side surface of the fifth lens L5;
d9: the on-axis thickness of the fifth lens L5;
d10: the on-axis distance from the image-side surface of the fifth lens L5 to the object-side surface of the optical filter GF;
d11: the on-axis thickness of the optical filter GF;
d12: the on-axis distance from the image-side surface of the optical filter GF to the image surface Si;
nd: the refractive index of the d line (the d line refers to green light with a wavelength of 550 nm);
nd1: the refractive index of the d line of the first lens L1;
nd2: the refractive index of the d line of the second lens L2;
nd3: the refractive index of the d line of the third lens L3;
nd4: the refractive index of the d line of the fourth lens L4;
nd5: the refractive index of the d line of the fifth lens L5;
ndg: the refractive index of the d line of the optical filter GF;
vd: the abbe number;
v1: the abbe number of first lens L1;
v2: the abbe number of second lens L2;
v3: the abbe number of the third lens L3;
v4: the abbe number of the fourth lens L4;
v5: the abbe number of the fifth lens L5; and
vg: the abbe number of the optical filter GF.

Table 2 shows aspherical data of each of the lenses in the camera optical lens 10 according to the first embodiment of the present disclosure.

TABLE 2

| | Conic coefficient | Aspheric surface coefficients | | | | |
|---|---|---|---|---|---|---|
| | k | A4 | A6 | A8 | A10 | A12 |
| R1 | −4.8018E+00 | 1.7612E−01 | −6.5923E−01 | 5.6619E+00 | −6.7759E+01 | 6.2999E+02 |
| R2 | −4.2656E+01 | 2.8258E−01 | −8.4496E+00 | 1.3640E+02 | −1.4158E+03 | 9.6912E+03 |
| R3 | −9.9000E+01 | 2.3363E−01 | −1.2070E+01 | 2.1379E+02 | −2.3860E+03 | 1.7755E+04 |
| R4 | 8.9297E+01 | −4.6730E−01 | 3.8644E+00 | −4.8494E+01 | 4.1889E+02 | −2.6434E+03 |
| R5 | 7.6330E+00 | −1.2550E+00 | 2.3096E+01 | −3.8264E+02 | 4.0529E+03 | −2.9209E+04 |
| R6 | −9.8530E+01 | −2.3078E−01 | 5.9433E−01 | −3.7885E+00 | −4.4505E+01 | 5.7497E+02 |
| R7 | −9.2030E+01 | 3.7511E−01 | 1.1913E−01 | −1.0146E+01 | 5.3498E+01 | −1.6270E+02 |
| R8 | −9.3454E−01 | 8.9945E−01 | −1.8662E+00 | 1.4199E+00 | 4.1130E+00 | −1.6352E+01 |
| R9 | 9.2941E+00 | 3.4792E−01 | −2.2898E+00 | 4.9598E+00 | −6.9001E+00 | 6.7422E+00 |
| R10 | −2.9450E+00 | −3.0064E−01 | 2.8607E−01 | −2.1384E−01 | 1.3334E−01 | −7.4254E−02 |
| | Conic coefficient | Aspheric surface coefficients | | | | |
| | k | A14 | A16 | A18 | A20 | A22 |
| R1 | −4.8018E+00 | −3.6958E+03 | 1.3562E+04 | −3.1248E+04 | 4.3997E+04 | −3.4624E+04 |
| R2 | −4.2656E+01 | −4.4675E+04 | 1.3921E+05\| | 2.8868E+05 | 3.8112E+05 | 2.8951E+05 |
| R3 | −9.9000E+01 | −9.0942E+04 | 3.2424E+05 | −8.0167E+05 | 1.3456E+06 | −1.4611E+06 |
| R4 | 8.9297E+01 | 1.2351E+04 | −4.2383E+04 | 1.0501E+05 | −1.8390E+05 | 2.2074E+05 |
| R5 | 7.6330E+00 | 1.4863E+05 | −5.4423E+05\| | 1.4462E+06 | −2.7864E+06 | 3.8481E+06 |
| R6 | −9.8530E+01 | −2.9881E+03 | 9.3230E+03 | −1.9375E+04 | 2.7847E+04 | −2.7878E+04 |
| R7 | −9.2030E+01 | 3.3800E+02 | −5.0559E+02 | 5.5511E+02 | −4.4807E+02 | 2.6245E+02 |
| R8 | −9.3454E−01 | 2.9670E+01 | −3.4579E+01 | 2.8161E+01 | −1.6504E+01 | 6.9677E+00 |
| R9 | 9.2941E+00 | −4.7124E+00 | 2.3779E+00 | −8.7117E−01 | 2.3149E−01 | −4.4131E−02 |
| R10 | −2.9450E+00 | 3.6714E−02 | −1.4988E−02 | 4.7069E−03 | −1.0885E−03 | 1.7986E−04 |

| | Conic coefficient | Aspheric surface coefficients | | | |
|---|---|---|---|---|---|
| | k | A24 | A26 | A28 | A30 |
| R1 | −4.8018E+00 | 1.1678E+04 | 0.0000E+00 | 0.0000E+00 | 0.0000E+00 |
| R2 | −4.2656E+01 | 9.6225E+04 | 0.0000E+00 | 0.0000E+00 | 0.0000E+00 |
| R3 | −9.9000E+01 | 9.2495E+05 | −2.5905E+05 | 0.0000E+00 | 0.0000E+00 |
| R4 | 8.9297E+01 | −1.7232E+05 | 7.8729E+04 | −1.5978E+04 | 0.0000E+00 |
| R5 | 7.6330E+00 | −3.7089E+06 | 2.3675E+06 | −8.9907E+05 | 1.5372E+05 |
| R6 | −9.8530E+01 | 1.9122E+04 | −8.5772E+03 | 2.2679E+03 | −2.6812E+02 |
| R7 | −9.2030E+01 | −1.0824E+02 | 2.9694E+01 | −4.8422E+00 | 3.5328E−01 |
| R8 | −9.3454E−01 | −2.0708E+00 | 4.1080E−01 | −4.8734E−02 | 2.6095E−03 |
| R9 | 9.2941E+00 | 5.8807E−03 | −5.1999E−04 | 2.7412E−05 | −6.5203E−07 |
| R10 | −2.9450E+00 | −2.0533E−05 | 1.5336E−06 | −6.7287E−08 | 1.3132E−09 |

For convenience, the aspherical surface of each lens surface is the aspherical surface shown in the following formula (1). However, the present disclosure is not limited to the aspherical polynomial form represented by the formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

Where, k represents the Conic coefficient, A4, A6, A8, A10, A12, A14, A16, A18, A20, A22, A24, A26, A28, and A30 represent Aspheric surface coefficients, c represents curvature at the center of the optical surface, r represents the vertical distance between the point on the aspherical curve and the optical axis, and z represents the aspherical depth (the vertical distance between the point on the aspherical surface from the optical axis by r and a tangent plane tangent to the vertex on the optical axis of the aspherical surface).

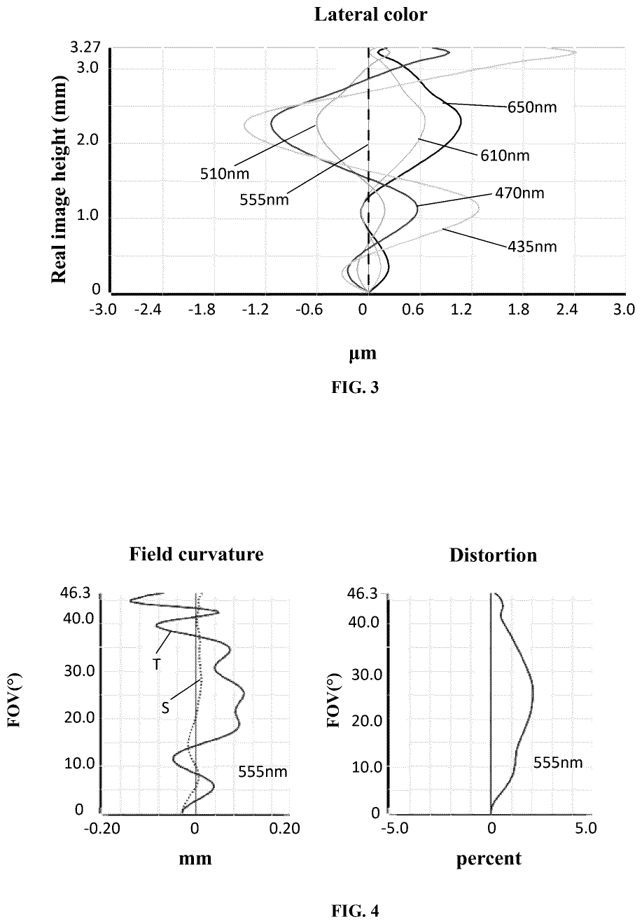

FIG. 2 and FIG. 3 show the longitudinal aberration and lateral color schematic diagrams after light with a wavelength of 650 nm, 610 nm, 555 nm, 510 nm, 470 nm, and 435 nm passes the camera optical lens 10 in the first embodiment. FIG. 4 shows the field curvature and distortion schematic diagrams after light with a wavelength of 555 nm passes the camera optical lens 10 in the first embodiment, the field curvature S in FIG. 4 is a field curvature in the sagittal direction, T is a field curvature in the meridian direction.

In this embodiment, the pupil entering diameter (ENPD) of the camera optical lens 10 is 1.449 mm, the full field-of-view image-height IH is 3.269 mm, and the field of view FOV in the diagonal direction is 92.63°. The camera optical lens 10 meets the design requirements of large aperture, ultra-thin, and wide-angle, and the on-axis and off-axis chromatic aberrations are fully corrected, thus having excellent optical characteristics.

### Second Embodiment

The meaning of symbols of the second embodiment is the same as that of the first embodiment.

FIG. 5 shows a camera optical lens 20 according to a second embodiment of the present disclosure.

Table 3 and table 4 show design data of the camera optical lens 20 according to the second embodiment of the present disclosure.

TABLE 3

| | R | d | | nd | | vd | |
|---|---|---|---|---|---|---|---|
| S1 | ∞ | d0 = | −0.101 | | | | |
| R1 | 1.648 | d1 = | 0.380 | nd1 | 1.5444 | v1 | 55.82 |
| R2 | 5.418 | d2 = | 0.377 | | | | |
| R3 | 20.411 | d3 = | 0.330 | nd2 | 1.5444 | v2 | 55.82 |
| R4 | −329.428 | d4 = | 0.108 | | | | |
| R5 | −3.841 | d5 = | 0.338 | nd3 | 1.6700 | v3 | 19.39 |
| R6 | −7.705 | d6 = | 0.214 | | | | |
| R7 | −19.646 | d7 = | 0.678 | nd4 | 1.5444 | v4 | 55.82 |
| R8 | −0.950 | d8 = | 0.124 | | | | |
| R9 | 7.972 | d9 = | 0.555 | nd5 | 1.5444 | v5 | 55.82 |
| R10 | 0.844 | d10 = | 0.627 | | | | |
| R11 | ∞ | d11 = | 0.210 | ndg | 1.5168 | vg | 64.17 |
| R12 | ∞ | d12 = | 0.292 | | | | |

Table 4 shows aspherical data of each lens in the camera optical lens 20 according to the second embodiment of the present disclosure.

TABLE 4

| | Conic coefficient | Aspheric surface coefficients | | | | |
|---|---|---|---|---|---|---|
| | k | A4 | A6 | A8 | A10 | A12 |
| R1 | −4.3936E+00 | 1.7704E−01 | −6.7159E−01 | 5.6564E+00 | −6.7761E+01 | 6.2998E+02 |
| R2 | −4.8257E+01 | 2.9549E−01 | −8.4245E+00 | 1.3639E+02 | −1.4158E+03 | 9.6912E+03 |
| R3 | 4.1595E+02 | 2.4457E−01 | −1.2109E+01 | 2.1379E+02 | −2.3860E+03 | 1.7756E+04 |
| R4 | 1.4979E+05 | −5.4752E−01 | 3.8525E+00 | −4.8499E+01 | 4.1886E+02 | −2.6434E+03 |
| R5 | 1.0284E+01 | −1.2736E+00 | 2.3066E+01 | −3.8265E+02 | 4.0529E+03 | −2.9209E+04 |
| R6 | −4.3046E+02 | −2.2699E−01 | 5.9015E−01 | −3.7955E+00 | −4.4508E+01 | 5.7497E+02 |
| R7 | −3.1129E+03 | 3.7658E−01 | 1.1890E−01 | −1.0147E+01 | 5.3499E+01 | −1.6270E+02 |
| R8 | −9.4507E−01 | 9.0210E−01 | −1.8652E+00 | 1.4202E+00 | 4.1131E+00 | −1.6352E+01 |
| R9 | 9.3316E+00 | 3.4853E−01 | −2.2897E+00 | 4.9598E+00 | −6.9001E+00 | 6.7422E+00 |
| R10 | −2.8484E+00 | −3.0045E−01 | 2.8636E−01 | −2.1384E−01 | 1.3334E−01 | −7.4254E−02 |
| | Conic coefficient | Aspheric surface coefficients | | | | |
| | k | A14 | A16 | A18 | A20 | A22 |
| R1 | −4.3936E+00 | −3.6958E+03 | 1.3562E+04 | −3.1249E+04 | 4.3996E+04 | −3.4624E+04 |
| R2 | −4.8257E+01 | −4.4675E+04 | 1.3921E+05 | −2.8868E+05 | 3.8112E+05 | −2.8951E+05 |
| R3 | 4.1595E+02 | −9.0942E+04 | 3.2424E+05 | −8.0167E+05 | 1.3456E+06 | −1.4611E+06 |
| R4 | 1.4979E+05 | 1.2351E+04 | −4.2383E+04 | 1.0501E+05 | −1.8390E+05 | 2.2074E+05 |
| R5 | 1.0284E+01 | 1.4863E+05 | −5.4423E+05 | 1.4462E+06 | −2.7864E+06 | 3.8481E+06 |
| R6 | −4.3046E+02 | −2.9881E+03 | 9.3230E+03 | −1.9375E+04 | 2.7847E+04 | −2.7878E+04 |
| R7 | −3.1129E+03 | 3.3800E+02 | −5.0559E+02 | 5.5511E+02 | −4.4807E+02 | 2.6245E+02 |
| R8 | −9.4507E−01 | 2.9671E+01 | −3.4579E+01 | 2.8161E+01 | −1.6504E+01 | 6.9677E+00 |
| R9 | 9.3316E+00 | −4.7124E+00 | 2.3779E+00 | −8.7117E−01 | 2.3149E−01 | −4.4131E−02 |
| R10 | −2.8484E+00 | 3.6714E−02 | −1.4988E−02 | 4.7069E−03 | −1.0885E−03 | 1.7986E−04 |

| | Conic coefficient | Aspheric surface coefficients | | | |
|---|---|---|---|---|---|
| | k | A24 | A26 | A28 | A30 |
| R1 | −4.3936E+00 | 1.1679E+04 | 0.0000E+00 | 0.0000E+00 | 0.0000E+00 |
| R2 | −4.8257E+01 | 9.6231E+04 | 0.0000E+00 | 0.0000E+00 | 0.0000E+00 |
| R3 | 4.1595E+02 | 9.2495E+05 | −2.5906E+05 | 0.0000E+00 | 0.0000E+00 |
| R4 | 1.4979E+05 | −1.7232E+05 | 7.8729E+04 | −1.5978E+04 | 0.0000E+00 |
| R5 | 1.0284E+01 | −3.7089E+06 | 2.3675E+06 | −8.9907E+05 | 1.5372E+05 |
| R6 | −4.3046E+02 | 1.9122E+04 | −8.5772E+03 | 2.2679E+03 | −2.6812E+02 |
| R7 | −3.1129E+03 | −1.0824E+02 | 2.9694E+01 | −4.8422E+00 | 3.5328E−01 |
| R8 | −9.4507E−01 | −2.0708E+00 | 4.1080E−01 | −4.8734E−02 | 2.6095E−03 |
| R9 | 9.3316E+00 | 5.8807E−03 | −5.1999E−04 | 2.7412E−05 | −6.5203E−07 |
| R10 | −2.8484E+00 | −2.0533E−05 | 1.5336E−06 | −6.7287E−08 | 1.3132E−09 |

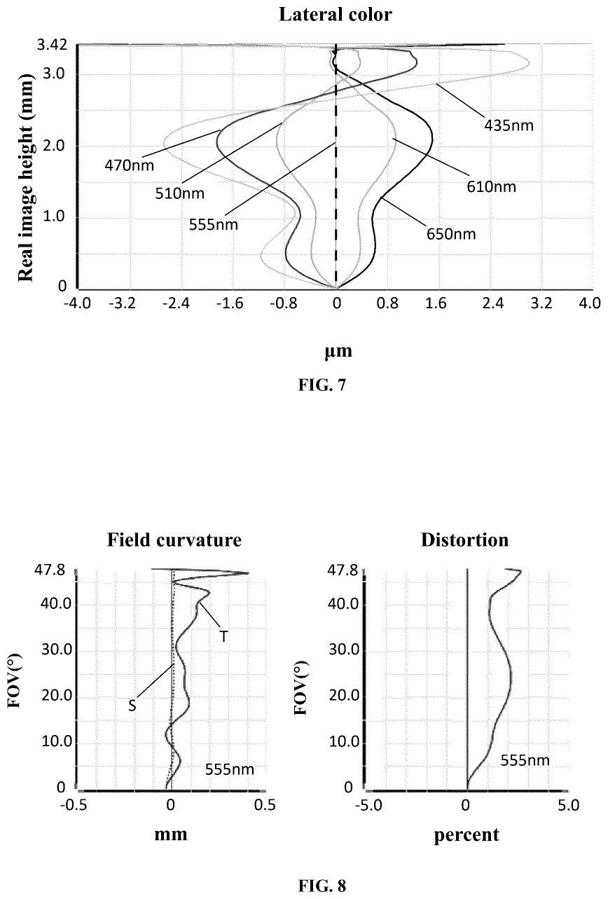

FIG. 6 and FIG. 7 show diagrams of longitudinal aberrations and lateral colors after light with a wavelength of 650 nm, 610 nm, 555 nm, 510 nm, 470 nm, and 435 nm passes the camera optical lens 20 of the second embodiment, respectively. FIG. 8 shows a schematic diagram of a field curvature and distortion after light with a wavelength of 555 nm passes the camera optical lens 20 of the second embodiment. The field curvature S in FIG. 8 is a field curvature in the sagittal direction, and T is a field curvature in the meridian direction.

In this embodiment, the pupil entering diameter ENPD of the camera optical lens 20 is 1.396 mm, the full field-of-view image-height IH is 3.269 mm, and the field of view FOV in the diagonal direction is 93.00°. The camera optical lens 20 meets the design requirements of large aperture, ultra-thin and wide-angle, and the on-axis and off-axis chromatic aberrations are fully corrected, thus having excellent optical characteristics.

### Third Embodiment

The meaning of symbols of the third embodiment is the same as that of the first embodiment.

FIG. 9 shows a camera optical lens 30 according to a third embodiment of the present disclosure. The object-side surface of the fourth lens L4 is convex in the paraxial region.

Table 5 and table 6 show design data of the camera optical lens 30 according to the third embodiment of the present disclosure.

TABLE 5

| | R | d | | nd | | vd | |
|---|---|---|---|---|---|---|---|
| S1 | ∞ | d0 = | −0.136 | | | | |
| R1 | 1.801 | d1 = | 0.762 | nd1 | 1.5444 | v1 | 55.82 |
| R2 | 6.998 | d2 = | 0.191 | | | | |
| R3 | 6.440 | d3 = | 0.339 | nd2 | 1.5444 | v2 | 55.82 |
| R4 | −23.463 | d4 = | 0.156 | | | | |
| R5 | −2.567 | d5 = | 0.361 | nd3 | 1.6700 | v3 | 19.39 |
| R6 | −38.467 | d6 = | 0.213 | | | | |
| R7 | 12.644 | d7 = | 0.678 | nd4 | 1.5444 | v4 | 55.82 |
| R8 | −0.985 | d8 = | 0.072 | | | | |
| R9 | 17.916 | d9 = | 0.665 | nd5 | 1.5444 | v5 | 55.82 |
| R10 | 0.929 | d10 = | 0.629 | | | | |
| R11 | ∞ | d11 = | 0.210 | ndg | 1.5168 | vg | 64.17 |
| R12 | ∞ | d12 = | 0.302 | | | | |

Table 6 shows aspherical data of each lens in the camera optical lens 30 according to the third embodiment of the present disclosure.

TABLE 6

| | Conic coefficient | Aspheric surface coefficients | | | | |
|---|---|---|---|---|---|---|
| | k | A4 | A6 | A8 | A10 | A12 |
| R1 | −8.4825E+00 | 1.8265E−01 | −6.2519E−01 | 5.6201E+00 | −6.7879E+01 | 6.2996E+02 |
| R2 | −2.4928E+02 | 2.5469E−01 | −8.4999E+00 | 1.3630E+02 | −1.4158E+03 | 9.6914E+03 |
| R3 | 1.1325E+01 | 2.6269E−01 | −1.2176E+01 | 2.1369E+02 | −2.3859E+03 | 1.7756E+04 |
| R4 | 7.6405E+02 | −4.0950E−01 | 3.8684E+00 | −4.8590E+01 | 4.1892E+02 | −2.6433E+03 |
| R5 | 7.7557E+00 | −1.2381E+00 | 2.3096E+01 | −3.8259E+02 | 4.0529E+03 | −2.9209E+04 |
| R6 | 9.8507E+02 | −2.6603E−01 | 5.8934E−01 | −3.8008E+00 | −4.4514E+01 | 5.7498E+02 |
| R7 | −3.2887E+02 | 3.7445E−01 | 1.1419E−01 | −1.0149E+01 | 5.3499E+01 | −1.6270E+02 |
| R8 | −9.3960E−01 | 9.0510E−01 | −1.8689E+00 | 1.4203E+00 | 4.1133E+00 | −1.6352E+01 |
| R9 | 3.9278E+01 | 3.5821E−01 | −2.2873E+00 | 4.9599E+00 | −6.9002E+00 | 6.7422E+00 |
| R10 | −2.9951E+00 | −2.9410E−01 | 2.8454E−01 | −2.1378E−01 | 1.3336E−01 | −7.4252E−02 |
| | Conic coefficient | Aspheric surface coefficients | | | | |
| | k | A14 | A16 | A18 | A20 | A22 |
| R1 | −8.4825E+00 | −3.6956E+03 | 1.3562E+04 | −3.1248E+04 | 4.3996E+04 | −3.4626E+04 |
| R2 | −2.4928E+02 | −4.4675E+04 | 1.3921E+05 | −2.8868E+05 | 3.8112E+05 | −2.8951E+05 |
| R3 | 1.1325E+01 | −9.0942E+04 | 3.2424E+05 | −8.0167E+05 | 1.3456E+06 | −1.4611E+06 |
| R4 | 7.6405E+02 | 1.2351E+04 | −4.2383E+04 | 1.0501E+05 | −1.8390E+05 | 2.2074E+05 |
| R5 | 7.7557E+00 | 1.4863E+05 | −5.4423E+05 | 1.4462E+06 | −2.7864E+06 | 3.8481E+06 |
| R6 | 9.8507E+02 | −2.9881E+03 | 9.3230E+03 | −1.9375E+04 | 2.7847E+04 | −2.7878E+04 |
| R7 | −3.2887E+02 | 3.3800E+02 | −5.0559E+02 | 5.5511E+02 | −4.4807E+02 | 2.6245E+02 |
| R8 | −9.3960E−01 | 2.9670E+01 | −3.4579E+01 | 2.8161E+01 | −1.6504E+01 | 6.9677E+00 |
| R9 | 3.9278E+01 | −4.7124E+00 | 2.3779E+00 | −8.7117E−01 | 2.3149E−01 | −4.4131E−02 |
| R10 | −2.9951E+00 | 3.6714E−02 | −1.4988E−02 | 4.7069E−03 | −1.0885E−03 | 1.7986E−04 |

| | Conic coefficient | Aspheric surface coefficients | | | |
|---|---|---|---|---|---|
| | k | A24 | A26 | A28 | A30 |
| R1 | −8.4825E+00 | 1.1678E+04 | 0.0000E+00 | 0.0000E+00 | 0.0000E+00 |
| R2 | −2.4928E+02 | 9.6224E+04 | 0.0000E+00 | 0.0000E+00 | 0.0000E+00 |
| R3 | 1.1325E+01 | 9.2495E+05 | −2.5905E+05 | 0.0000E+00 | 0.0000E+00 |
| R4 | 7.6405E+02 | −1.7232E+05 | 7.8729E+04 | −1.5978E+04 | 0.0000E+00 |
| R5 | 7.7557E+00 | −3.7089E+06 | 2.3675E+06 | −8.9907E+05 | 1.5372E+05 |
| R6 | 9.8507E+02 | 1.9122E+04 | −8.5772E+03 | 2.2679E+03 | −2.6812E+02 |
| R7 | −3.2887E+02 | −1.0824E+02 | 2.9693E+01 | −4.8421E+00 | 3.5333E−01 |
| R8 | −9.3960E−01 | −2.0708E+00 | 4.1080E−01 | −4.8734E−02 | 2.6094E−03 |
| R9 | 3.9278E+01 | 5.8807E−03 | −5.1999E−04 | 2.7412E−05 | −6.5202E−07 |
| R10 | −2.9951E+00 | −2.0533E−05 | 1.5336E−06 | −6.7287E−08 | 1.3132E−09 |

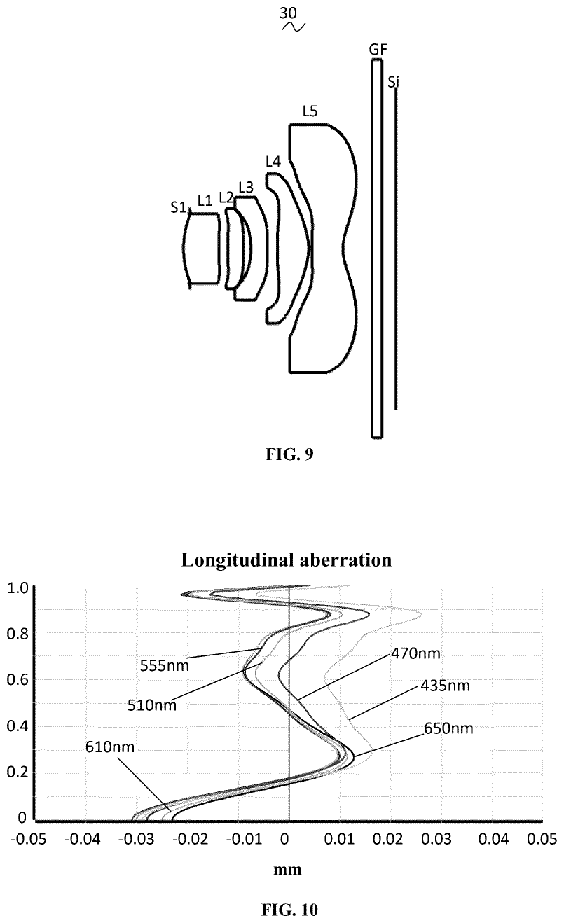

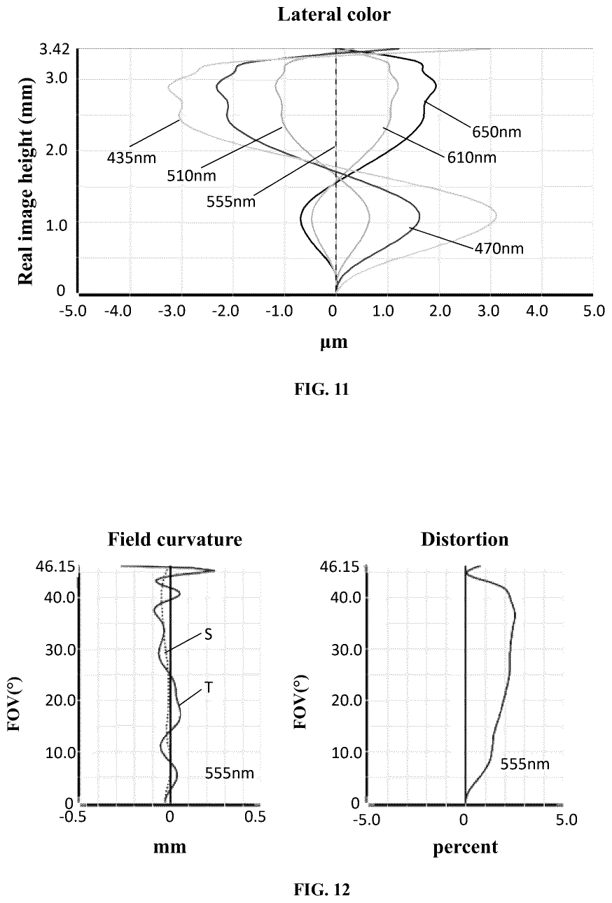

FIG. 10 and FIG. 11 show diagrams of longitudinal aberrations and lateral colors after light with a wavelength of 650 nm, 610 nm, 555 nm, 510 nm, 470 nm, and 435 nm passes the camera optical lens 30 of the third embodiment, respectively. FIG. 12 shows a schematic diagram of a field curvature and distortion after light with a wavelength of 555 nm passes the camera optical lens 30 of the third embodiment. The field curvature S in FIG. 12 is a field curvature in the sagittal direction, and T is a field curvature in the meridian direction.

In this embodiment, the pupil entering diameter ENPD of the camera optical lens 30 is 1.468 mm, the full field-of-view image-height IH is 3.269 mm, and the field of view FOV in the diagonal direction is 90.01°. The camera optical lens 30 meets the design requirements of large aperture, ultra-thin, and wide-angle, and the on-axis and off-axis chromatic aberrations are fully corrected, thus having excellent optical characteristics.

### Fourth Embodiment

The meaning of symbols of the fourth embodiment is the same as that of the first embodiment.

FIG. 13 shows a camera optical lens 40 according to a fourth embodiment of the present disclosure. The image-side surface of the second lens L2 is concave in the paraxial region.

Table 7 and table 8 show design data of the camera optical lens 40 according to the fourth embodiment of the present disclosure.

TABLE 7

| | R | d | | nd | | vd | |
|---|---|---|---|---|---|---|---|
| S1 | ∞ | d0 = | −0.071 | | | | |
| R1 | 1.525 | d1 = | 0.425 | nd1 | 1.5444 | v1 | 55.82 |
| R2 | 4.794 | d2 = | 0.311 | | | | |
| R3 | 5.864 | d3 = | 0.453 | nd2 | 1.5444 | v2 | 55.82 |
| R4 | 42.189 | d4 = | 0.087 | | | | |
| R5 | −2.555 | d5 = | 0.291 | nd3 | 1.6700 | v3 | 19.39 |
| R6 | −10.469 | d6 = | 0.132 | | | | |
| R7 | −4.084 | d7 = | 0.492 | nd4 | 1.5444 | v4 | 55.82 |
| R8 | −0.981 | d8 = | 0.131 | | | | |
| R9 | 3.242 | d9 = | 0.877 | nd5 | 1.5444 | v5 | 55.82 |
| R10 | 1.002 | d10 = | 0.676 | | | | |
| R11 | ∞ | d11 = | 0.210 | ndg | 1.5168 | vg | 64.17 |
| R12 | ∞ | d12 = | 0.399 | | | | |

Table 8 shows aspherical data of each lens in the camera optical lens 40 according to the fourth embodiment of the present disclosure.

TABLE 8

| | Conic coefficient | Aspheric surface coefficients | | | | |
|---|---|---|---|---|---|---|
| | k | A4 | A6 | A8 | A10 | A12 |
| R1 | −5.5609E+00 | 2.0854E−01 | −6.0817E−01 | 5.5099E+00 | −6.7898E+01 | 6.2999E+02 |
| R2 | −1.5413E+00 | 2.6037E−01 | −8.6584E+00 | 1.3647E+02 | −1.4152E+03 | 9.6919E+03 |
| R3 | −6.8843E+01 | 2.0621E−01 | −1.2155E+01 | 2.1365E+02 | −2.3861E+03 | 1.7755E+04 |
| R4 | 2.4725E+03 | −4.5799E−01 | 3.6781E+00 | −4.8684E+01 | 4.1893E+02 | −2.6432E+03 |
| R5 | 8.2597E+00 | −1.2699E+00 | 2.3218E+01 | −3.8262E+02 | 4.0528E+03 | −2.9209E+04 |
| R6 | 8.7748E+01 | −2.5905E−01 | 6.0012E−01 | −3.7848E+00 | −4.4510E+01 | 5.7497E+02 |
| R7 | −3.1805E+02 | 4.0221E−01 | 4.5485E−02 | −1.0151E+01 | 5.3506E+01 | −1.6270E+02 |
| R8 | −8.9934E−01 | 8.7086E−01 | −1.8558E+00 | 1.4235E+00 | 4.1137E+00 | −1.6352E+01 |
| R9 | 3.9864E+00 | 3.1997E−01 | −2.2952E+00 | 4.9513E+00 | −6.9010E+00 | 6.7423E+00 |
| R10 | −2.0259E+00 | −3.1818E−01 | 2.8869E−01 | −2.1384E−01 | 1.3332E−01 | −7.4257E−02 |
| | Conic coefficient | Aspheric surface coefficients | | | | |
| | k | A14 | A16 | A18 | A20 | A22 |
| R1 | −5.5609E+00 | −3.6954E+03 | 1.3562E+04 | −3.1249E+04 | 4.3993E+04 | −3.4632E+04 |
| R2 | −1.5413E+00 | −4.4677E+04 | 1.3920E+05 | −2.8870E+05 | 3.8110E+05 | −2.8948E+05 |
| R3 | −6.8843E+01 | −9.0943E+04 | 3.2424E+05 | −8.0167E+05 | 1.3456E+06 | −1.4611E+06 |
| R4 | 2.4725E+03 | 1.2351E+04 | −4.2383E+04 | 1.0501E+05 | −1.8390E+05 | 2.2074E+05 |
| R5 | 8.2597E+00 | 1.4863E+05 | −5.4423E+05 | 1.4462E+06 | −2.7864E+06 | 3.8481E+06 |
| R6 | 8.7748E+01 | −2.9881E+03 | 9.3230E+03 | −1.9375E+04 | 2.7847E+04 | −2.7878E+04 |
| R7 | −3.1805E+02 | 3.3800E+02 | −5.0559E+02 | 5.5511E+02 | −4.4807E+02 | 2.6245E+02 |
| R8 | −8.9934E−01 | 2.9670E+01 | −3.4579E+01 | 2.8161E+01 | −1.6504E+01 | 6.9676E+00 |
| R9 | 3.9864E+00 | −4.7123E+00 | 2.3779E+00 | −8.7121E−01 | 2.3147E−01 | −4.4139E−02 |
| R10 | −2.0259E+00 | 3.6714E−02 | −1.4988E−02 | 4.7069E−03 | −1.0885E−03 | 1.7986E−04 |

| | Conic coefficient | Aspheric surface coefficients | | | |
|---|---|---|---|---|---|
| | k | A24 | A26 | A28 | A30 |
| R1 | −5.5609E+00 | 1.1684E+04 | 0.0000E+00 | 0.0000E+00 | 0.0000E+00 |
| R2 | −1.5413E+00 | 9.6613E+04 | 0.0000E+00 | 0.0000E+00 | 0.0000E+00 |
| R3 | −6.8843E+01 | 9.2498E+05 | −2.5902E+05 | 0.0000E+00 | 0.0000E+00 |
| R4 | 2.4725E+03 | −1.7232E+05 | 7.8728E+04 | −1.5981E+04 | 0.0000E+00 |
| R5 | 8.2597E+00 | −3.7089E+06 | 2.3675E+06 | −8.9907E+05 | 1.5372E+05 |
| R6 | 8.7748E+01 | 1.9122E+04 | −8.5772E+03 | 2.2679E+03 | −2.6812E+02 |
| R7 | −3.1805E+02 | −1.0824E+02 | 2.9694E+01 | 4.8421E+00 | 3.5319E−01 |
| R8 | −8.9934E−01 | −2.0708E+00 | 4.1080E−01 | −4.8729E−02 | 2.6172E−03 |
| R9 | 3.9864E+00 | 5.8771E−03 | −5.2122E−04 | 2.6814E−05 | −7.7276E−07 |
| R10 | −2.0259E+00 | −2.0533E−05 | 1.5336E−06 | −6.7286E−08 | 1.3136E−09 |

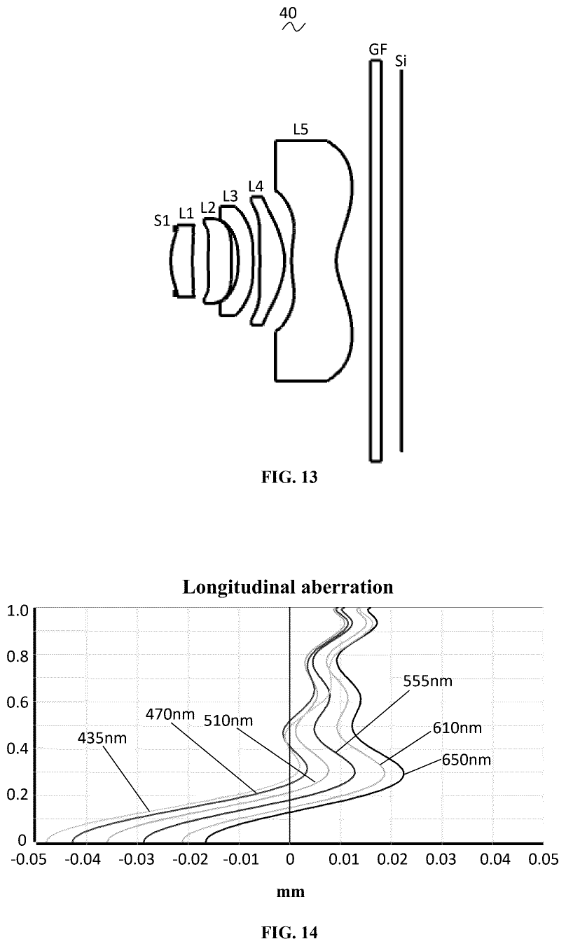

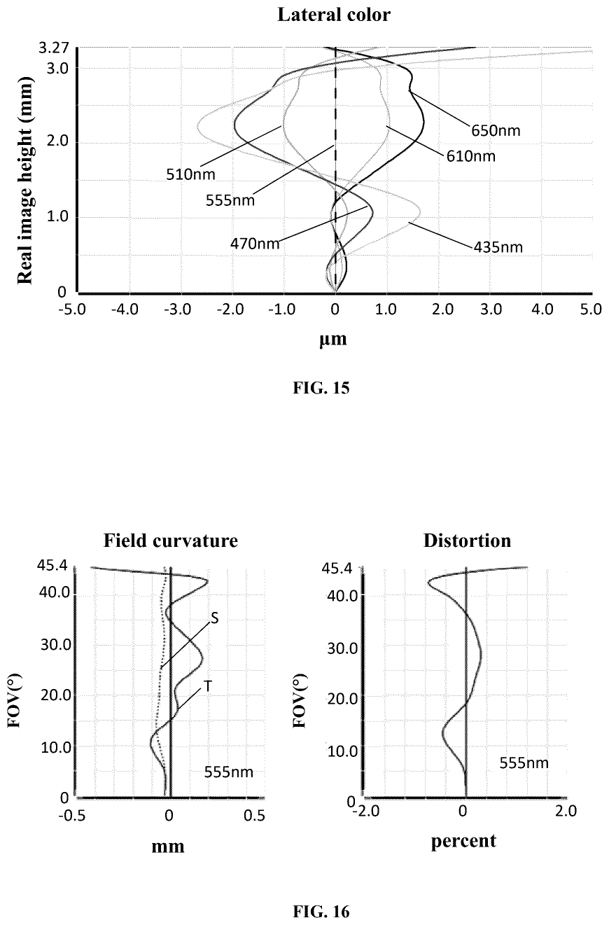

FIG. 14 and FIG. 15 show diagrams of longitudinal aberrations and lateral colors after light with a wavelength of 650 nm, 610 nm, 555 nm, 510 nm, 470 nm, and 435 nm passes the camera optical lens 40 of the fourth embodiment, respectively. FIG. 16 shows a schematic diagram of a field curvature and distortion after light with a wavelength of 555 nm passes the camera optical lens 40 of the fourth embodiment. The field curvature S in FIG. 16 is a field curvature in the sagittal direction, and T is a field curvature in the meridian direction.

In this embodiment, the pupil entering diameter ENPD of the camera optical lens 40 is 1.207 mm, the full field-of-view image-height IH is 3.269 mm, and the field of view FOV in the diagonal direction is 90.88°. The camera optical lens 40 meets the design requirements of large aperture, ultra-thin, and wide-angle, and the on-axis and off-axis chromatic aberrations are fully corrected, thus having excellent optical characteristics.

Table 11, which appears later, shows the values corresponding to the parameters specified in the conditional formula for each of the values in the first, second, third and fourth embodiments.

### Comparative Example

The meaning of symbols of the comparative example is the same as that of the first embodiment.

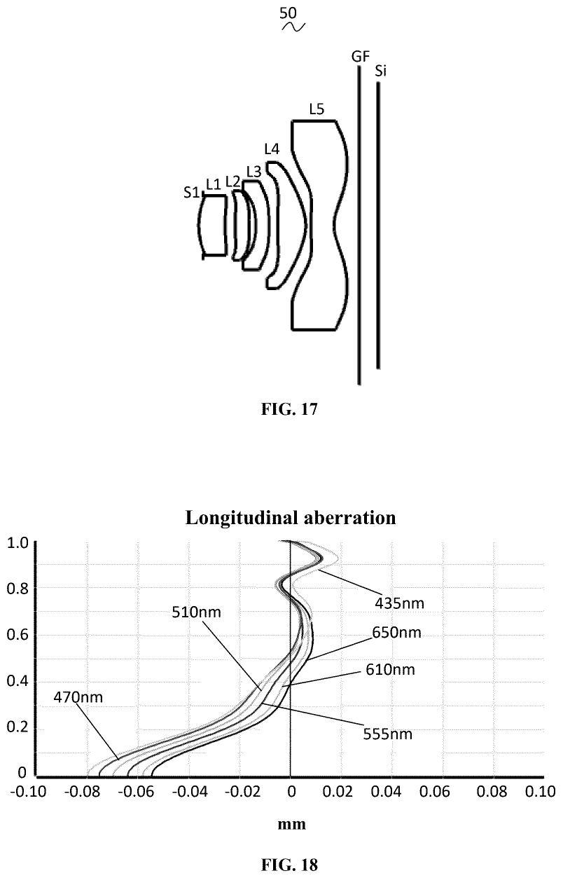

FIG. 17 shows a camera optical lens 50 according to a comparative example.

Table 9 and table 10 show design data of the camera optical lens 50 of the comparative example.

TABLE 9

| | R | d | | nd | | vd | |
|---|---|---|---|---|---|---|---|
| S1 | ∞ | d0 = | −0.107 | | | | |
| R1 | 1.674 | d1 = | 0.634 | nd1 | 1.5444 | v1 | 55.82 |
| R2 | 4.282 | d2 = | 0.247 | | | | |
| R3 | 7.049 | d3 = | 0.338 | nd2 | 1.5444 | v2 | 55.82 |
| R4 | −13.292 | d4 = | 0.155 | | | | |
| R5 | −3.196 | d5 = | 0.317 | nd3 | 1.6700 | v3 | 19.39 |
| R6 | −14.948 | d6 = | 0.212 | | | | |
| R7 | −22.994 | d7 = | 0.674 | nd4 | 1.5444 | v4 | 55.82 |
| R8 | −0.967 | d8 = | 0.125 | | | | |
| R9 | 7.900 | d9 = | 0.552 | nd5 | 1.5444 | v5 | 55.82 |
| R10 | 0.858 | d10 = | 0.607 | | | | |
| R11 | ∞ | d11 = | 0.210 | ndg | 1.5168 | vg | 64.17 |
| R12 | ∞ | d12 = | 0.254 | | | | |

Table 10 shows aspherical data of each lens in the camera optical lens 50 of the comparative example.

TABLE 10

| | Conic coefficient | Aspheric surface coefficients | | | | |
|---|---|---|---|---|---|---|
| | k | A4 | A6 | A8 | A10 | A12 |
| R1 | −5.5696E+00 | 1.6714E−01 | −6.2639E−01 | 5.6588E+00 | −6.7798E+01 | 6.3001E+02 |
| R2 | −3.5973E+01 | 2.8419E−01 | −8.4009E+00 | 1.3627E+02 | −1.4158E+03 | 9.6914E+03 |
| R3 | −2.9213E+01 | 2.5135E−01 | −1.2015E+01 | 2.1357E+02 | −2.3859E+03 | 1.7755E+04 |
| R4 | 2.3705E+02 | −4.4764E−01 | 3.8446E+00 | −4.8469E+01 | 4.1887E+02 | −2.6434E+03 |
| R5 | 7.7630E+00 | −1.2631E+00 | 2.3109E+01 | 3.8265E+02 | 4.0529E+03 | −2.9209E+04 |
| R6 | −5.0087E+02 | −2.3674E−01 | 5.9631E−01 | −3.7931E+00 | −4.4511E+01 | 5.7497E+02 |
| R7 | 3.0882E+02 | 3.7827E−01 | 1.0893E−01 | −1.0145E+01 | 5.3508E+01 | −1.6271E+02 |
| R8 | −9.0127E−01 | 8.9272E−01 | −1.8619E+00 | 1.4178E+00 | 4.1135E+00 | −1.6352E+01 |
| R9 | 9.1665E+00 | 3.4353E−01 | −2.2889E+00 | 4.9595E+00 | −6.9001E+00 | 6.7422E+00 |
| R10 | −2.8549E+00 | −2.9979E−01 | 2.8662E−01 | −2.1385E−01 | 1.3334E−01 | −7.4254E−02 |
| | Conic coefficient | Aspheric surface coefficients | | | | |
| | k | A14 | A16 | A18 | A20 | A22 |
| R1 | −5.5696E+00 | −3.6958E+03 | 1.3562E+04 | −3.1250E+04 | 4.3996E+04 | −3.4626E+04 |
| R2 | −3.5973E+01 | −4.4675E+04 | 1.3921E+05 | −2.8868E+05 | 3.8112E+05 | −2.8952E+05 |
| R3 | −2.9213E+01 | −9.0941E+04 | 3.2424E+05 | −8.0167E+05 | 1.3456E+06 | −1.4611E+06 |
| R4 | 2.3705E+02 | 1.2351E+04 | −4.2383E+04 | 1.0501E+05 | −1.8390E+05 | 2.2074E+05 |
| R5 | 7.7630E+00 | 1.4863E+05 | −5.4423E+05 | 1.4462E+06 | −2.7864E+06 | 3.8481E+06 |
| R6 | −5.0087E+02 | −2.9881E+03 | 9.3230E+03 | −1.9375E+04 | 2.7847E+04 | −2.7878E+04 |
| R7 | 3.0882E+02 | 3.3799E+02 | −5.0559E+02 | 5.5511E+02 | −4.4807E+02 | 2.6245E+02 |
| R8 | −9.0127E−01 | 2.9670E+01 | −3.4579E+01 | 2.8161E+01 | −1.6504E+01 | 6.9677E+00 |
| R9 | 9.1665E+00 | −4.7124E+00 | 2.3779E+00 | −8.7117E−01 | 2.3149E−01 | −4.4131E−02 |
| R10 | −2.8549E+00 | 3.6714E−02 | −1.4988E−02 | 4.7069E−03 | −1.0885E−03 | 1.7986E−04 |

| | Conic coefficient | Aspheric surface coefficients | | | |
|---|---|---|---|---|---|
| | k | A24 | A26 | A28 | A30 |
| R1 | −5.5696E+00 | 1.1685E+04 | 0.0000E+00 | 0.0000E+00 | 0.0000E+00 |
| R2 | −3.5973E+01 | 9.6236E+04 | 0.0000E+00 | 0.0000E+00 | 0.0000E+00 |
| R3 | −2.9213E+01 | 9.2496E+05 | −2.5905E+05 | 0.0000E+00 | 0.0000E+00 |
| R4 | 2.3705E+02 | −1.7232E+05 | 7.8729E+04 | −1.5978E+04 | 0.0000E+00 |
| R5 | 7.7630E+00 | −3.7089E+06 | 2.3675E+06 | 8.9907E+05 | 1.5372E+05 |
| R6 | −5.0087E+02 | 1.9122E+04 | −8.5772E+03 | 2.2679E+03 | −2.6812E+02 |
| R7 | 3.0882E+02 | −1.0824E+02 | 2.9694E+01 | −4.8422E+00 | 3.5329E−01 |
| R8 | −9.0127E−01 | −2.0708E+00 | 4.1080E−01 | 4.8734E−02 | 2.6095E−03 |
| R9 | 9.1665E+00 | 5.8807E−03 | −5.1999E−04 | 2.7412E−05 | −6.5205E−07 |
| R10 | −2.8549E+00 | −2.0533E−05 | 1.5336E−06 | −6.7288E−08 | 1.3133E−09 |

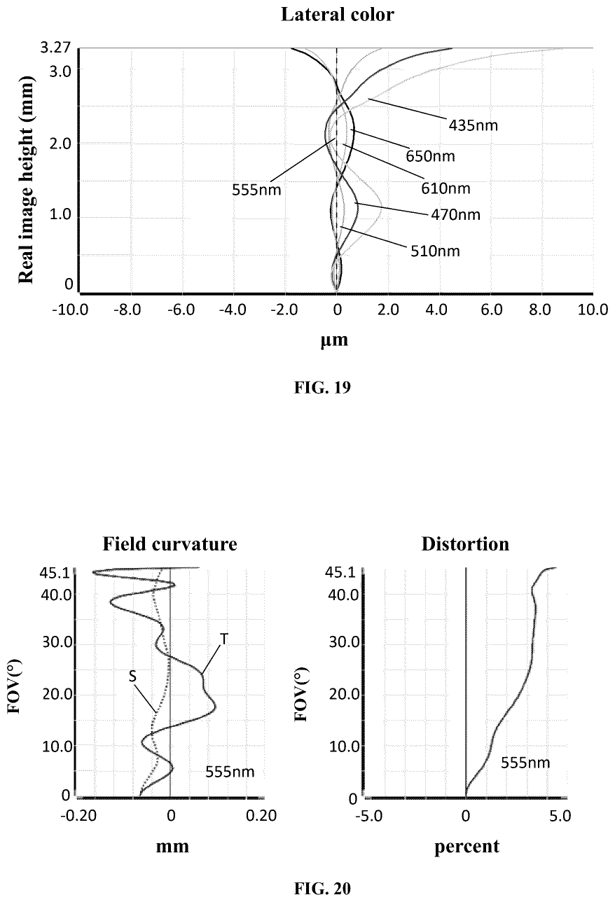

FIG. 18 and FIG. 19 show diagrams of longitudinal aberrations and lateral colors after light with a wavelength of 650 nm, 610 nm, 555 nm, 510 nm, 470 nm, and 435 nm passes the camera optical lens 50 of the comparative example, respectively. FIG. 20 shows a schematic diagram of a field curvature and distortion after light with a wavelength of 555 nm passes the camera optical lens 50 of the comparative example. The field curvature S in FIG. 20 is a field curvature in the sagittal direction, and T is a field curvature in the meridian direction.

Table 11 below lists the values of the corresponding conditional expressions in the comparative example according to the above conditional expressions. Obviously, the camera optical lens 50 of the comparative example does not satisfy the above-described conditional formula 3.00≤f2/f≤12.00, thus having poor imaging effect.

In this embodiment, the pupil entering diameter ENPD of the camera optical lens 50 is 1.444 mm, the full field-of-view image-height IH is 3.269 mm, and the field of view FOV in the diagonal direction is 90.33°, such that the camera optical lens 50 does not meet the design requirements of large aperture, ultra-thin, and wide-angle.

TABLE 11

| Parameter and | Embodiment | Embodiment | Embodiment | Embodiment | comparative |
|---|---|---|---|---|---|
| conditional formula | 1 | 2 | 3 | 4 | example |
| f2/f | 6.255 | 11.970 | 3.004 | 4.882 | 2.789 |
| (R9 + R10)/(R9 − R10) | 1.247 | 1.237 | 1.109 | 1.895 | 1.244 |
| d1/d2 | 2.071 | 1.008 | 3.990 | 1.367 | 2.567 |
| R6/R5 | 4.957 | 2.006 | 14.985 | 4.097 | 4.677 |
| f | 3.052 | 2.941 | 3.092 | 2.543 | 3.042 |
| f1 | 4.201 | 4.187 | 4.221 | 3.915 | 4.635 |
| f2 | 19.090 | 35.203 | 9.289 | 12.414 | 8.483 |
| f3 | −6.839 | −11.739 | −4.085 | −5.075 | −6.078 |
| f4 | 1.773 | 1.804 | 1.703 | 2.237 | 1.828 |
| f5 | −1.833 | −1.777 | −1.819 | −3.080 | −1.812 |
| f12 | 3.573 | 3.813 | 3.102 | 3.099 | 3.230 |
| FNO | 2.106 | 2.107 | 2.106 | 2.107 | 2.107 |
| TTL | 4.301 | 4.233 | 4.578 | 4.484 | 4.325 |

Those of ordinary skill in the art will appreciate that the above embodiments are embodiments of the present disclosure, and that in practical application, various changes can be made to them in form and detail without departing from the spirit and scope of the present disclosure.

What is claimed is:

1. A camera optical lens, comprising five lenses, wherein the five lenses include, from an object side to an image side in sequence: a first lens having a positive refractive power, a second lens having a positive refractive power, a third lens having a negative refractive power, a fourth lens having a positive refractive power, and a fifth lens having a negative refractive power;
wherein the camera optical lens satisfies following relationships:
$$\begin{matrix}3. \leq f 2 / f \leq 12. ; \\ 1.1 \leq ( R 9 + R 10 ) / ( R 9 - R 10 ) \leq 1.9 ; \\ 1. \leq d 1 / d 2 \leq 4. ; and \\ 2. \leq R 6 / R 5 \leq 15. ;\end{matrix}$$
wherein f represents a focal length of the camera optical lens, f2 represents a focal length of the second lens, R9 represents a central curvature radius of an object-side surface of the fifth lens, R10 represents a central curvature radius of an image-side surface of the fifth lens, d1 represents an on-axis thickness of the first lens, d2 represents an on-axis distance from an image-side surface of the first lens to an object-side surface of the second lens, R5 represents a central curvature radius of an object-side surface of the third lens, and R6 represents a central curvature radius of an image-side surface of the third lens.

2. The camera optical lens of claim 1, wherein the camera optical lens further satisfies a following relationship:
$$1. ⩽ d 6 / d 8 ⩽ 3. ;$$
wherein d6 represents an on-axis distance from the image-side surface of the third lens to an object-side surface of the fourth lens, and d8 represents an on-axis distance from an image-side surface of the fourth lens to the object-side surface of the fifth lens.

3. The camera optical lens of claim 1, wherein the camera optical lens further satisfies a following relationship:
$$- 4. \leq f 3 / f \leq - 1.2 ;$$
wherein f3 represents a focal length of the third lens.

4. The camera optical lens of claim 1, wherein an object-side surface of the first lens is convex in a paraxial region and the image-side surface of the first lens is concave in the paraxial region;
wherein the camera optical lens further satisfies a following relationship:
$$\begin{matrix}0.68 \leq f 1 / f \leq 2.31 ; \\ - 3.87 \leq ( R 1 + R 2 ) / ( R 1 - R 2 ) \leq - 1.13 ; and \\ 0.04 \leq d 1 / TTL \leq 0.25 ;\end{matrix}$$
wherein f1 represents a focal length of the first lens, R1 represents a central curvature radius of the object-side surface of the first lens, R2 represents a central curvature radius of the image-side surface of the first lens, and TTL represents a total track length of the camera optical lens.

5. The camera optical lens of claim 1, wherein the object-side surface of the second lens is convex in a paraxial region;
wherein the camera optical lens further satisfies a following relationship:
$$\begin{matrix}- 2.65 \leq ( R 3 + R 4 ) / ( R 3 - R 4 ) \leq - 0.38 ; and \\ 0.04 \leq d 3 / TTL \leq 0.15 ;\end{matrix}$$
wherein R3 represents a central curvature radius of the object-side surface of the second lens, R4 represents a central curvature radius of an image-side surface of the second lens, d3 represents an on-axis thickness of the second lens, and TTL represents a total track length of the camera optical lens.

6. The camera optical lens of claim 1, wherein the object-side surface of the third lens is concave in a paraxial region and the image-side surface of the third lens is convex in the paraxial region;
wherein the camera optical lens further satisfies a following relationship:
$$\begin{matrix}- 5.98 \leq ( R 5 + R 6 ) / ( R 5 - R 6 ) \leq - 0.76 ; and \\ 0.003 \leq d 5 / TTL \leq 0.12 ;\end{matrix}$$
wherein d5 represents an on-axis thickness of the third lens and TTL represents a total track length of the camera optical lens.

7. The camera optical lens of claim 1, wherein an image-side surface of the fourth lens is convex in a paraxial region;
wherein the camera optical lens further satisfies a following relationship:
$$\begin{matrix}0.28 \leq f 4 / f \leq 1.32 ; \\ 0.43 \leq ( R 7 + R 8 ) / ( R 7 - R 8 ) \leq 2.45 ; and \\ 0.05 \leq d 7 / TTL \leq 0.24 ;\end{matrix}$$
wherein f4 represents a focal length of the fourth lens, R7 represents a central curvature radius of an object-side surface of the fourth lens, R8 represents a central curvature radius of an image-side surface of the fourth lens, d7 represents an on-axis thickness of the fourth lens, and TTL represents a total track length of the camera optical lens.

8. The camera optical lens of claim 1, wherein the object-side surface of the fifth lens is convex in a paraxial region and the image-side surface of the fifth lens is concave in the paraxial region;
wherein the camera optical lens further satisfies a following relationship:
$$\begin{matrix}- 2.42 \leq f 5 / f \leq - 0.39 ; and \\ 0.07 \leq d 9 / TTL \leq 0.29 ;\end{matrix}$$
wherein f5 represents a focal length of the fifth lens, d9 represents an on-axis thickness of the fifth lens and TTL represents a total track length of the camera optical lens.

9. The camera optical lens of claim 1, wherein the camera optical lens further satisfies a following relationship:
$$TTL / H \leq 1.4 ;$$
wherein TTL represents a total track length of the camera optical lens and IH represents a maximum image height of the camera optical lens.

10. The camera optical lens of claim 1, wherein the camera optical lens further satisfies a following relationship:
$$0.5 \leq f 12 / f \leq 1.94 ;$$
wherein f12 represents a combined focal length of the first lens and the second lens.
